(19) United States
(12) Patent Application Publication
(10) Pub. No.: US 2026/0299287 A1
(43) Pub. Date: Oct. 1, 2026

(54) CALIBRATION METHOD FOR TRANSMITTANCE OF OPTICAL LENS

(71) Applicant: CHANGSHA LUBON PHOTOELECTRIC TECHNOLOGY CO., LTD., Changsha (CN)

(72) Inventors: Wenzhi CHENG, Changsha (CN); Shui HAN, Changsha (CN); Xiaochun LI, Changsha (CN)

(21) Appl. No.: 19/416,465

(22) Filed: Dec. 11, 2025

Related U.S. Application Data
(63) Continuation of application No. PCT/CN2025/119289, filed on Sep. 5, 2025.

(30) Foreign Application Priority Data
Mar. 28, 2025 (CN) 202510384576.0

(51) Int. Cl. G02B 27/00

(52) U.S. Cl. CPC G02B 27/0012

(57) ABSTRACT

A calibration method for transmittance of optical lens relates to the field of optical technologies. The method includes: a series of flats is deployed on a spherical surface of a hemispherical coating fixture and coating is performed by using a same process as a target lens; a transmittance, corresponding to a target incident angle, of the coated surface of each flat at the same target edge position is measured; a two-dimensional curve, corresponding to the target incident angle, of an included angle between a first connection line and a second connection line gradually changes with the transmittance in a gradient change process by fitting is obtained based on a measured edge transmittance of each flat and coordinate information on the coating fixture; and each two-dimensional curve is saved as a reference standard of improving or verifying a edge transmittance of the target lens for future recall.

### CROSS-REFERENCE TO RELATED APPLICATION

The present application is a continuation of International Patent Application No. PCT/CN2025/119289, filed on Sep. 5, 2025, which claims priority to Chinese Patent Application No. 202510384576.0, filed with the China National Intellectual Property Administration on Mar. 28, 2025 and entitled “CALIBRATION METHOD FOR TRANSMITTANCE OF OPTICAL LENS”, both of which are incorporated herein by reference in their entireties.

### TECHNICAL FIELD

The present disclosure relates to the field of optical technologies, and in particular to a calibration method for transmittance of optical lens.

### BACKGROUND

In some application scenarios of optical lenses, the requirement for transmittance uniformity is high. For example: because of the lenses having curved surfaces, coating films are not uniform in thickness during the evaporation coating with an electronic gun.

During the coating process of the optical lenses, the thicknesses of the coating films are not uniform due to holding with a fixture and/or a process, thus causing transmittances of edge portions to be less than transmittances of central portions.

Still further, in some harsh light path environments, in order to avoid the problem of non-uniform transmittances of the lenses, such as coated lenses, caused when angles of incident light rays are excessively large, it is necessary to consider whether the transmittances of the edge portions meet the requirement during the design of a light path product. However, there is no prior art for achieving this purpose, and this problem has become a technical challenge in this industry.

### SUMMARY

An object of the present disclosure is to disclose a calibration method for transmittance optical lens to assist in improving or verifying an edge transmittance of a target lens.

To achieve the above object, the calibration method for transmittance of optical lens disclosed in the present disclosure includes: deploying a series of flats on a spherical surface of a hemispherical coating fixture; measuring a transmittance, corresponding to a target incident angle, of a coated surface of each of the series of flats at a same target edge position; where the target edge position is an edge position for clamping reserved by a clear aperture of the target lens for a matching coating fixture, and an edge position of each flat clamped by the hemispherical coating fixture is consistent with the edge position of the target lens clamped by the matching coating fixture; obtaining a two-dimensional curve, corresponding to the target incident angle, of an included angle between a first connection line and a second connection line gradually changes with the transmittance in a gradient change process by fitting based on a measured edge transmittance of each flat and coordinate information on the hemispherical coating fixture; where the first connection line is a connection line between any coordinate point on the spherical surface and a spherical center of the hemispherical coating fixture, and the second connection line is a connection line between a vertex of the spherical surface and the spherical center of the hemispherical coating fixture; also, different target incident angles correspond to different two-dimensional curves; and saving the two-dimensional curve as a reference standard of improving or verifying an edge transmittance of the target lens for future recall.

In an implementation, the method of the present disclosure further includes the following steps: during a design of the target lens being applied to a target light path product, determining a series of solution sets of the target lens in the target light path product, then obtaining an incident angle at a target edge corresponding to any solution of the series of solution sets, finding the two-dimensional curve corresponding to the incident angle, determining a first included angle between an optical axis and a connection line between the target edge position of an incident surface and a spherical center of the incident surface, and a second included angle between the optical axis and a connection line between the target edge position of an emergent surface and a spherical center of the emergent surface, then finding transmittances corresponding to the first included angle and the second included angle respectively from the two-dimensional curve, determining a product of multiplying two found transmittances as an edge transmittance of a current solution, and later screening out a solution having an optimal edge transmittance by comparing edge transmittances corresponding to solutions of the series of solution sets.

In an implementation, during a design of the target lens being applied to a target light path product, when determining a series of solution sets of the target lens in the target light path product, setting a constraint condition of the edge transmittance, obtaining an incident angle at a target edge corresponding to any design, then finding the two-dimensional curve corresponding to the incident angle, determining a first included angle between an optical axis and a connection line between the target edge position of an incident surface and a spherical center of the incident surface, and a second included angle between the optical axis and a connection line between the target edge position of an emergent surface and a spherical center of the emergent surface, then finding transmittances corresponding to the first included angle and the second included angle respectively from the two-dimensional curve, determining a product of multiplying two found transmittances as the edge transmittance of a current design, later judging whether the edge transmittance satisfies the constraint condition or not, and if not satisfies the constraint condition, determining the current design as an invalid design, which is not allowed to be included in the series of solution sets of the target lens in the target light path product.

In an implementation, the method of the present disclosure further includes the following steps: during a design of the target lens being applied to a target light path product, determining a target transmittance of the target lens in the target light path product and an incident angle at a target edge, and then assigning curvature radii of an incident surface and an emergent surface according to the two-dimensional curve corresponding to the incident angle to enable a product of multiplying transmittances of the incident surface and the emergent surface at the target edge to be equal to or greater than the target transmittance.

In an implementation, each flat has a circular cross section, and the target edge position of the target lens is a position 2 mm away from an outer contour of each flat.

The present disclosure achieves the following beneficial effects. Calibration results processed by a series of steps can map different target lenses, after target technological coating with the matching coating fixture, the transmittances, at the target edge, of the incident and emergent surfaces of various flexibly-varying target lenses corresponding respectively at different angles of beam incidence can be determined precisely on the basis of the gradually changing transmittances corresponding to coordinate points on the incident surface and the emergent surface during actual use, and thus the overall transmittance of the target lens at the target edge can be properly verified or improved at a product design stage.

### BRIEF DESCRIPTION OF THE DRAWINGS

To illustrate the technical solutions in the examples of the present application or conventional art more clearly, the accompanying drawings required for the examples are briefly described below. Apparently, the accompanying drawings in the following description show merely some examples of the present application, and those of ordinary skill in the art may still derive other accompanying drawings from these accompanying drawings without creative efforts.

FIG. 1 shows a schematic flowchart of a calibration method for transmittance of optical lens according to an embodiment of the present disclosure.

FIG. 2 shows a schematic diagram illustrating the distribution of calibration flats on a hemispherical coating fixture according to an embodiment of the present disclosure.

FIG. 3 shows a schematic diagram of a light path for determining the transmittance, corresponding to a target incident angle, of a coated surface of each flat at the same target edge position according to an embodiment of the present disclosure.

FIG. 4 shows a schematic diagram of two-dimensional curves, after the fitting of included angles and target edge transmittances calibrated at two different incident angles of 10°and 30°, according to an embodiment of the present disclosure.

FIG. 5 shows a schematic diagram of two-dimensional curves, after the fitting of a coefficient γ and the target edge transmittances calibrated at two different incident angles of 10° and 30°, after the deformation of FIG. 4.

### DETAILED DESCRIPTION OF THE EMBODIMENTS

The technical solutions of embodiments of the present application will be clearly and completely described below with reference to the accompanying drawings in the examples of the present application. Apparently, the embodiments described are merely some rather than all of the embodiments of the present application. Based on the examples of the present application, all other examples that would have been obtained by those of ordinary skill in the art without any creative efforts shall fall within the scope of protection of the present application.

To make the above object, features and advantages of the present application clearer and more comprehensible, the present application is further described in detail below with reference to the accompanying drawings and specific implementations.

### Example 1

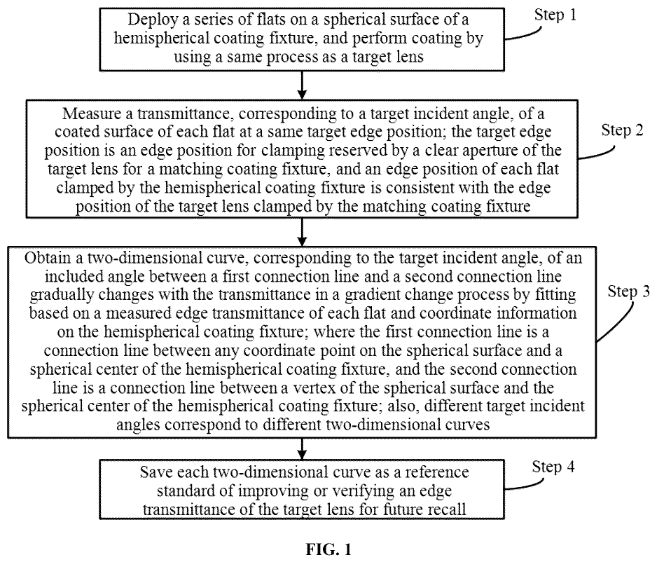

This embodiment discloses a calibration method for transmittance of optical lens. As shown in FIG. 1, the method includes the steps.

Step 1, a series of flats is deployed on a spherical surface of a hemispherical coating fixture.

In this step, a conventional large-sized lens may generally be referenced for the dimensions of the hemispherical coating fixture, and optionally, the spherical radius of the hemispherical coating fixture may be 75 mm. The mentioned flat is an ordinary glass substrate with a coated surface that is a horizontal surface, and has a circular cross section.

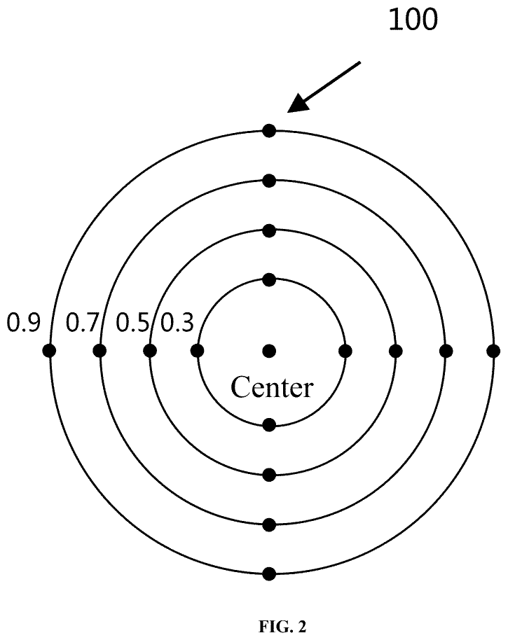

In this step, FIG. 2 may be referenced for the deployment of the series of flats, dots 100 in FIG. 2 represent the deployment positions of the series of flats from top view, and different sized circles in FIG. 2 are ratios of vertical distances from corresponding coordinate points to connection line between a vertex on the spherical surface and the spherical center (the connection lines are the symmetry axis of the hemispherical coating fixture), to the spherical radius. For convenience of description, the ratios are defined as “P value” in this embodiment, for example, 0.3, 0.5, 0.7 and 0.9 in FIG. 2, where when the flat is at the vertex (i.e., center) of the coating fixture, the P value is 0, and when the flat is at the bottom-most edge of the coating fixture, the P value is 1. However, in actual deployment, the largest P value of each flat that can be placed at the bottom is about 0.9. Typically, the closer the flat is placed at the bottom edge of the coating fixture, the lower the corresponding transmittance thereof is.

Step 2, a transmittance, corresponding to a target incident angle, of the coated surface of each flat at the same target edge position is measured; the target edge position is an edge position reserved for holding a target lens having a clear aperture by a matching coating fixture, and the edge position of each flat held by the hemispherical coating fixture is consistent with the edge position of the target lens held by the matching coating fixture.

In this step, in order to improve the efficiency of mass production and control costs, the matching coating fixture of the target lens may be a large-diameter coating fixture having a bottom diameter of 1.1 m. A housing contour of the coating fixture is also generally a partially hollow sphere, and the surface of the coating fixture is provided with several accommodating cavities for coated lens and has a holding function in the coating process.

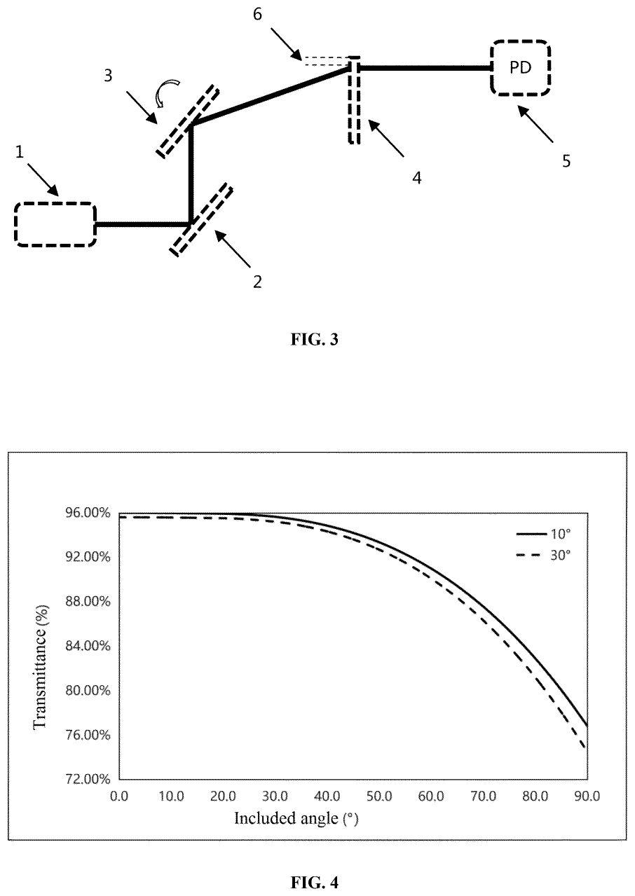

In this step, a light path shown in FIG. 3 may be used to measure the transmittance, corresponding to the target incident angle, of the coated surface of each flat at the same target edge position. Emergent light of a laser 1 passes through two reflectors (a first reflector 2 and a second reflector 3), which mainly plays the role of simulating a galvanometer scanner to change a scanning angle. By adjusting an angle of the second reflector 3 (the reflector is rotated by 1°, allowing the direction of light rays to change by 2°), an angle of incident light ray is adjusted. A flat 4 to be measured is moved horizontally such that the light ray is incident to a position 6 at about 2 mm away from the edge of the lens (the position at about 2 mm is a position at the edge of the clear aperture reserved for the coating fixture). An optical power of the lens is tested by a power meter 5, an optical power of the light not passing through the flat is then tested at this angle, and a ratio of the two optical power is an edge transmittance of the lens.

Step 3, a two-dimensional curve, corresponding to the target incident angle, of an included angle between a first connection line and a second connection line gradually changes with the transmittance in a gradient change process by fitting is obtained based on a measured edge transmittance of each flat and coordinate information on the coating fixture; where the first connection line is a connection line between any coordinate point on the spherical surface and a spherical center of the coating fixture, and the second connection line is a connection line between a vertex of the spherical surface and the spherical center of the coating fixture; also, different target incident angles correspond to different two-dimensional curves.

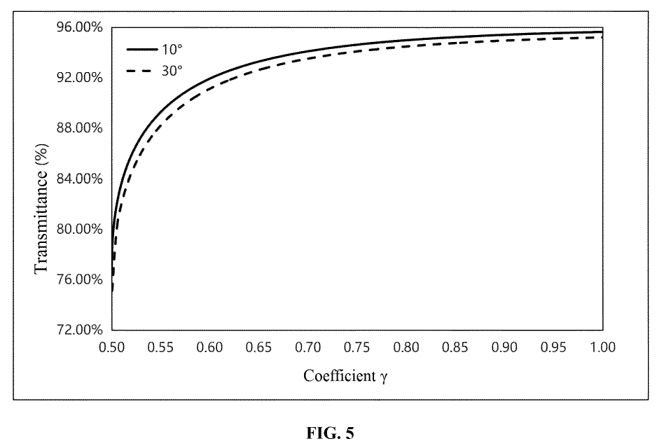

In this step, as shown in FIG. 4, the fitted two-dimensional curve essentially illustrates a distribution trend of the transmittance at the same target edge position in the coating process as the included angle gradually changes. Further, Those skilled in the art, under the teachings of the present disclosure, can derive a variety of manifestations according to the distribution trend of the transmittance at the same target edge position in the coating process as the included angle gradually changes. For example, the included angle formed between the first connection line and the second connection line is defined as φ, a coefficient γ is then defined as 0.5/sin(φ), and fitted gradient change curves of the coefficient γ versus the transmittance at two different incident angles of 10° and 30°can then be as shown in FIG. 5. Such modifications are all equivalent substitutions, but still fall within the scope of protection of the present disclosure.

In step 4, each two-dimensional curve is saved as a reference standard of improving or verifying a edge transmittance of the target lens for future recall.

In this step, utilization methods based on the calibrated two-dimensional curves include, but are not limited to, the following three methods.

First, during the design of the target lens being applied to the target light path product, a series of solution sets of the target lens in the target light path product is determined, an incident angle at a target edge corresponding to any solution is then obtained, the two-dimensional curve corresponding to the incident angle is found, a first included angle between an optical axis and a connection line between the target edge position of an incident surface and a spherical center of the incident surface, and a second included angle between the optical axis and a connection line between the target edge position of an emergent surface and a spherical center of the emergent surface are determined, transmittances corresponding to the first included angle and the second included angle respectively are then found from the two-dimensional curve, a product of multiplying the two found transmittances is determined as an edge transmittance of the current solution, and a solution having an optimal edge transmittance is then screened out by comparing the edge transmittances corresponding to the solutions.

Second, during the design of the target lens being applied to a target light path product, when a series of solution sets of the target lens in the target light path product is determined, a constraint condition of the edge transmittance is set, an incident angle at a target edge corresponding to any design is obtained, the two-dimensional curve corresponding to the incident angle is then found, a first included angle between an optical axis and a connection line between the target edge position of an incident surface and a spherical center of the incident surface, and a second included angle between the optical axis and a connection line between the target edge position of an emergent surface and a spherical center of the emergent surface are determined, transmittances corresponding to the first included angle and the second included angle respectively are found from the two-dimensional curve, a product of multiplying the two found transmittances is determined as the edge transmittance of the current design, whether the edge transmittance satisfies the constraint condition or not is later judged, and if not satisfies the constraint condition, the current design is determined as an invalid design, which is not allowed to be included in the series of solution sets of the target lens in the target light path product.

Third, during the design of the target lens being applied to the target light path product, a target transmittance of the target lens in the target light path product and an incident angle at the target edge are determined, curvature radii of an incident surface and an emergent surface are then assigned according to the two-dimensional curve corresponding to the incident angle to enable a product of multiplying transmittances of the two surfaces at the target edge to be equal to or greater than the target transmittance.

In summary, the calibration method for transmittance of optical lens disclosed in embodiments of the present disclosure achieves at least the following beneficial effects.

Calibration results processed by a series of steps can map different target lenses, after target technological coating with the matching coating fixture, the transmittances, at the target edge, of the incident and emergent surfaces of various flexibly-varying target lenses corresponding respectively at different angles of beam incidence can be determined precisely on the basis of the gradually changing transmittances corresponding to coordinate points on the incident surface and the emergent surface during actual use, and thus the overall transmittance of the target lens at the target edge can be properly verified or improved at a product design stage.

The technical features of the above embodiments may be combined arbitrarily. To make the description concise, all possible combinations of the technical features in the above embodiments are not described. However, these combinations should be considered to be within the scope of the description of the present disclosure as long as there is no contradiction in the combinations of these technical features.

In the text, the principle and embodiments of the present application are described herein by using specific examples, the above descriptions of the embodiments are merely intended to help understand the methods and core idea of the present application. In addition, for those of ordinary skill in the art, changes may be made to the specific embodiments and the scope of application according to the concept of the present application. In summary, the content of the description should not be construed as a limitation to the present application.

What is claimed is:

1. A calibration method for transmittance of optical lens, comprising:
deploying a series of flats on a spherical surface of a hemispherical coating fixture and performing coating by using a same process as a target lens;
measuring a transmittance, corresponding to a target incident angle, of a coated surface of each of the series of flats at a same target edge position; wherein the target edge position is an edge position for clamping reserved by a clear aperture of the target lens for a matching coating fixture, and an edge position of each flat clamped by the hemispherical coating fixture is consistent with the edge position of the target lens clamped by the matching coating fixture;
obtaining a two-dimensional curve, corresponding to the target incident angle, of an included angle between a first connection line and a second connection line gradually changes with the transmittance in a gradient change process by fitting based on a measured edge transmittance of each flat and coordinate information on the hemispherical coating fixture; wherein the first connection line is a connection line between any coordinate point on the spherical surface and a spherical center of the hemispherical coating fixture, and the second connection line is a connection line between a vertex of the spherical surface and the spherical center of the hemispherical coating fixture; also, different target incident angles correspond to different two-dimensional curves; and
saving the two-dimensional curve as a reference standard of improving or verifying an edge transmittance of the target lens for future recall.

2. The calibration method for transmittance of optical lens according to claim 1, further comprising:
during a design of the target lens being applied to a target light path product, determining a series of solution sets of the target lens in the target light path product, then obtaining an incident angle at a target edge corresponding to any solution of the series of solution sets, finding the two-dimensional curve corresponding to the incident angle, determining a first included angle between an optical axis and a connection line between the target edge position of an incident surface and a spherical center of the incident surface, and a second included angle between the optical axis and a connection line between the target edge position of an emergent surface and a spherical center of the emergent surface, then finding transmittances corresponding to the first included angle and the second included angle respectively from the two-dimensional curve, determining a product of multiplying two found transmittances as an edge transmittance of a current solution, and later screening out a solution having an optimal edge transmittance by comparing edge transmittances corresponding to solutions of the series of solution sets.

3. The calibration method for transmittance of optical lens according to claim 1, further comprising:
during a design of the target lens being applied to a target light path product, when determining a series of solution sets of the target lens in the target light path product, setting a constraint condition of the edge transmittance, obtaining an incident angle at a target edge corresponding to any design, then finding the two-dimensional curve corresponding to the incident angle, determining a first included angle between an optical axis and a connection line between the target edge position of an incident surface and a spherical center of the incident surface, and a second included angle between the optical axis and a connection line between the target edge position of an emergent surface and a spherical center of the emergent surface, then finding transmittances corresponding to the first included angle and the second included angle respectively from the two-dimensional curve, determining a product of multiplying two found transmittances as the edge transmittance of a current design, later judging whether the edge transmittance satisfies the constraint condition or not, and if not satisfies the constraint condition, determining the current design as an invalid design, which is not allowed to be included in the series of solution sets of the target lens in the target light path product.

4. The calibration method for transmittance of optical lens according to claim 1, further comprising:
during a design of the target lens being applied to a target light path product, determining a target transmittance of the target lens in the target light path product and an incident angle at a target edge, and then assigning curvature radii of an incident surface and an emergent surface according to the two-dimensional curve corresponding to the incident angle to enable a product of multiplying transmittances of the incident surface and the emergent surface at the target edge to be equal to or greater than the target transmittance.

5. The calibration method for transmittance of optical lens according to claim 1, wherein each flat has a circular cross section, and the target edge position of the target lens is a position 2 mm away from an outer contour of each flat.

6. The calibration method for transmittance of optical lens according to claim 2, wherein each flat has a circular cross section, and the target edge position of the target lens is a position 2 mm away from an outer contour of each flat.

7. The calibration method for transmittance of optical lens according to claim 3, wherein each flat has a circular cross section, and the target edge position of the target lens is a position 2 mm away from an outer contour of each flat.

8. The calibration method for transmittance of optical lens according to claim 4, wherein each flat has a circular cross section, and the target edge position of the target lens is a position 2 mm away from an outer contour of each flat.
